(19) United States
(12) Patent Application Publication
(10) Pub. No.: US 2020/0384548 A1
(43) Pub. Date: Dec. 10, 2020

(54) HAMMER DRILL HAVING ULTRASONIC VIBRATION DEVICE

(71) Applicant: YING HSIN LIANG, Taichung City (TW)

(72) Inventor: YING HSIN LIANG, Taichung City (TW)

(21) Appl. No.: 16/433,270

(22) Filed: Jun. 6, 2019

(51) Int. Cl. B23B 37/00; B23B 45/02

(52) U.S. Cl. CPC B23B 37/00; B23B 2260/10; B23B 45/02

(57) ABSTRACT

A hammer drill includes a housing including an axial fastener secured to a chuck, and an anchor member secured to the fastener; an ultrasonic vibration device fastened in the housing and including a magnetic hollow cylinder on the fastener, a hollow cylindrical seat around the magnetic hollow cylinder, an exciting coil on the hollow cylindrical seat, a magnetic first member secured to a first magnet, a first portion of the hollow cylindrical seat, and a first portion of the exciting coil, and a magnetic second member secured to a second magnet, a second portion of the hollow cylindrical seat, and a second portion of the exciting coil; and an energy supplying device disposed on the housing and including an inner winding on the housing and electrically connected to the exciting coil, and an outer winding spaced from the inner winding.

### BACKGROUND OF THE INVENTION

### 1. Field of the Invention

The invention relates to hammer drills and more particularly to a hammer drill including an ultrasonic vibration device having an increased precision in machining with greatly decreased resistance and wearing.

### 2. Description of Related Art

A conventional hammer drill includes a device for generating ultrasonic vibration. The ultrasonic vibration generation device is made of piezoelectric ceramic material and is capable of supplying electricity by means of a contact slip ring.

However, a drill bit attached to a chuck of the hammer drill may generate high heat and sparks in high speed rotation. It may lower the performance of the contact slip ring, thereby adversely affecting stability of electricity supplying of the ultrasonic vibration generation device and the drilling operation. Moreover, the piezoelectric ceramic material has a maximum energy density of 2,500 J/m⁻³, a lower mechatronics coupling coefficient of 0.68 K₃₃, a lower expansion coefficient of about 400/μm·m⁻¹ which undesirably provides a smaller ultrasonic amplitude, and a lower Curie point of about 300° C. which undesirably withstands a lower working temperature.

Thus, the need for improvement still exists.

### SUMMARY OF THE INVENTION

It is therefore one object of the invention to provide a hammer drill comprising a housing including a chuck tapered toward a free end, an axial fastener secured to the chuck, and an anchor member secured to the axial fastener; an ultrasonic vibration device disposed in the housing and secured by both the anchor member and the axial fastener, the ultrasonic vibration device including a magnetic hollow cylinder disposed on the axial fastener, a hollow cylindrical seat disposed around the magnetic hollow cylinder, an exciting coil disposed on the hollow cylindrical seat, a magnetic first member secured to a first magnet, a first portion of the hollow cylindrical seat, and a first portion of the exciting coil, and a magnetic second member secured to a second magnet, a second portion of the hollow cylindrical seat, and a second portion of the exciting coil; and an energy supplying device disposed on an outer surface of the housing and including an inner winding disposed on the outer surface of the housing and electrically connected to the exciting coil, and an outer winding spaced from the inner winding.

Preferably, the ultrasonic vibration device further comprises the first and second magnets of bias magnetic field at two ends of the magnetic hollow cylinder respectively.

Preferably, the outer winding has a shape of one quarter arc.

Preferably, the anchor member is secured to a head of the axial fastener opposing the chuck.

Preferably, the axial fastener is hollow.

Preferably, the outer winding is electrically connected to a controller.

Preferably, the first and second magnets of bias magnetic field are neodymium magnets.

The above and other objects, features and advantages of the invention will become apparent from the following detailed description taken with the accompanying drawings.

### BRIEF DESCRIPTION OF THE DRAWINGS

FIG. 1 is a perspective view of a hammer drill according to a first preferred embodiment of the invention;

FIG. 2 is a longitudinal section view of the hammer drill;

FIG. 3 is a longitudinal section view of a hammer drill according to a second preferred embodiment of the invention;

FIG. 4 is a longitudinal section view of a hammer drill according to a third preferred embodiment of the invention; and

FIG. 5 is a perspective view of the hammer drill electrically connected to a controller.

### DETAILED DESCRIPTION OF THE INVENTION

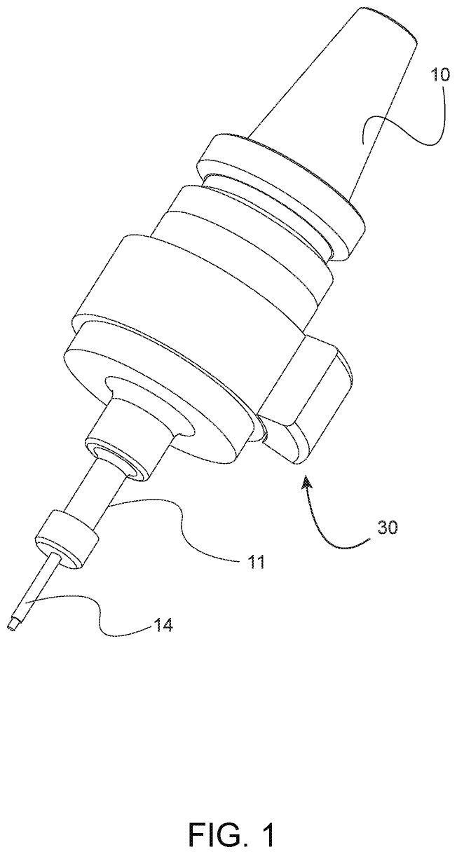

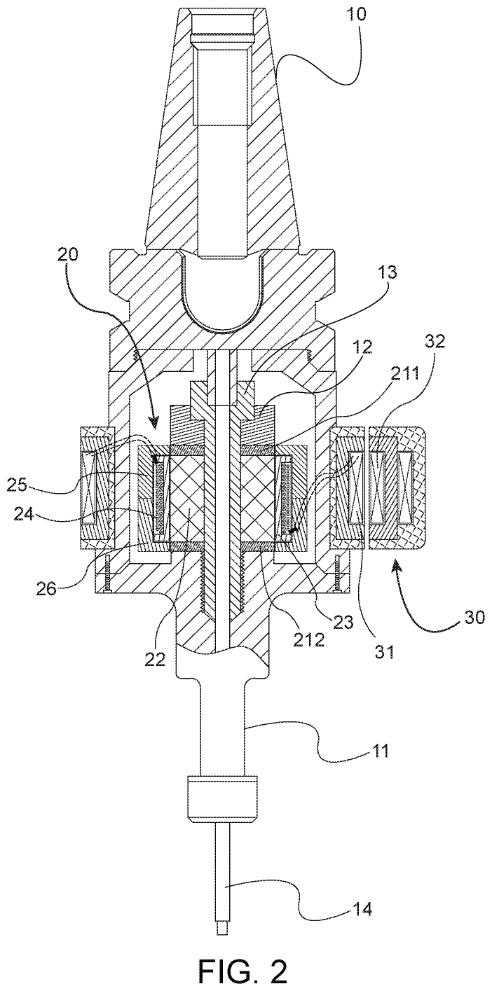

Referring to FIGS. 1 and 2, a hammer drill in accordance with a first preferred embodiment of the invention comprises a housing 10 including a chuck 11 tapered toward a free end, a drill bit 14 attached to the chuck 11, an axial hollow fastener 13 secured to the chuck 11, and an anchor member 12 secured to a head of the axial hollow fastener 13; an ultrasonic vibration device 20 disposed in the housing 10 and secured by both the anchor member 12 and the axial hollow fastener 13; and an energy supplying device 30 disposed on an outer surface of an intermediate portion of the housing 10.

The ultrasonic vibration device 20 comprises a magnetic hollow cylinder 22 disposed on the axial hollow fastener 13, first and second magnets 211, 212 of bias magnetic field at two ends of the magnetic hollow cylinder 22 respectively, a hollow cylindrical seat 23 disposed around the magnetic hollow cylinder 22, an exciting coil 24 disposed on the hollow cylindrical seat 23, a magnetic first member 25 secured to the first magnet 211, an upper portion of the hollow cylindrical seat 23, and an upper portion of the exciting coil 24, and a magnetic second member 26 secured to the second magnet 212, a lower portion of the hollow cylindrical seat 23, and a lower portion of the exciting coil 24.

The first and second magnets 211, 212 of bias magnetic field are neodymium magnets. The magnetic hollow cylinder 22 is made of magnetostrictive material such as Terfenol-D.

The energy supplying device 30 comprises an inner winding 31 disposed on the outer surface of the intermediate portion of the housing 10 and electrically connected to the exciting coil 24, and an outer winding 32 having a shape of one quarter arc and spaced from the inner winding 31.

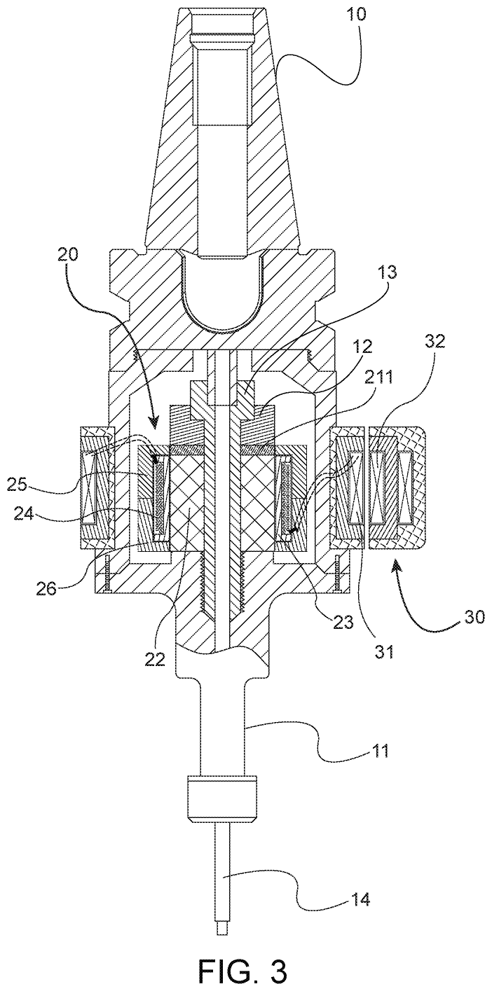

Referring to FIG. 3, a hammer drill in accordance with a second preferred embodiment of the invention is shown. The characteristics of the second preferred embodiment are substantially the same as that of the first preferred embodiment except the following: the second magnet 212 of bias magnetic field is eliminated.

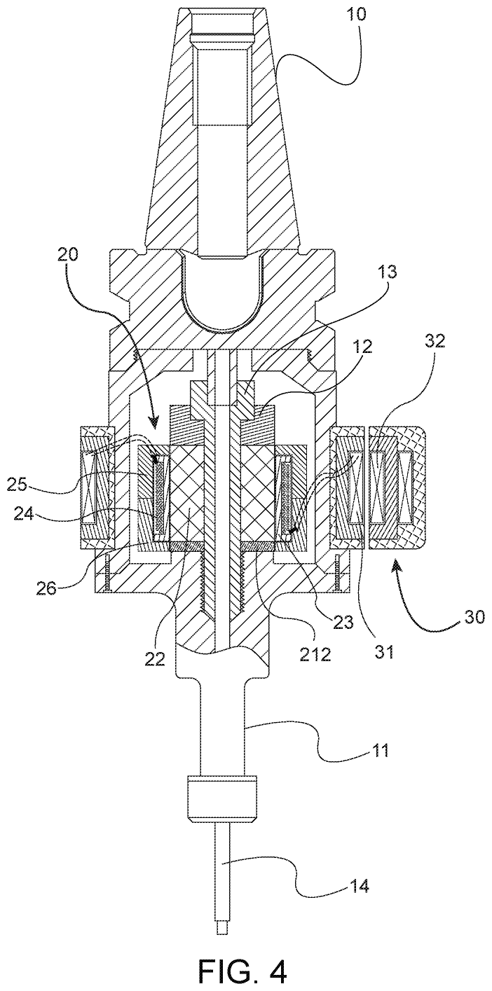

Referring to FIG. 4, a hammer drill in accordance with a third preferred embodiment of the invention is shown. The characteristics of the third preferred embodiment are substantially the same as that of the first preferred embodiment except the following: the first magnet 211 of bias magnetic field is eliminated.

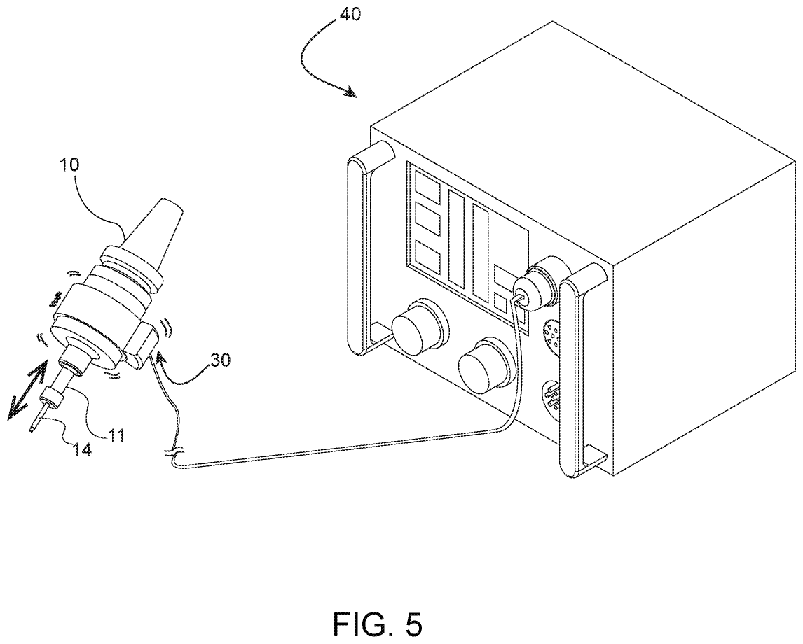

Referring to FIG. 5 in conjunction with FIGS. 2 to 4, the outer winding 32 is electrically connected to a controller 40 which can control frequency, voltage and current and supply power to the energy supplying device 30. After the outer winding 32 has been energized, a magnetic field is generated between the inner winding 31 and the outer winding 32. Electric current is generated in the inner winding 31 due to the magnetic field and supplied to the exciting coil 24. And in turn, the electric current is supplied from the exciting coil 24 to the ultrasonic vibration device 20 for activation. As a result, the housing 10 including the chuck 11 vibrates strongly due to ultrasonic high frequency vibration. As a result, the drill bit 14 has an increased precision in machining with greatly decreased resistance and wearing.

The invention has the following advantages and benefits in comparison with the conventional art: it has a maximum energy density in the rang of 14,000-25,000 J/m⁻³, a higher output power, a higher mechatronics coupling coefficient of about 0.72 K₃₃, a higher expansion coefficient in the rang of 1,500-2,000/μm·m⁻¹ for providing a greater ultrasonic amplitude, and a higher Curie point of about 387° C. for withstanding a higher working temperature all because the magnetic hollow cylinder is made of the magnetostrictive material. Moreover, the housing can be shaped as a cylinder.

While the invention has been described in terms of preferred embodiments, those skilled in the art will recognize that the invention can be practiced with modifications within the spirit and scope of the appended claims.

What is claimed is:

1. A hammer drill, comprising:
a housing including a chuck tapered toward a free end, an axial fastener secured to the chuck, and an anchor member secured to the axial fastener;
an ultrasonic vibration device disposed in the housing and secured by both the anchor member and the axial fastener, the ultrasonic vibration device including a magnetic hollow cylinder disposed on the axial fastener, a hollow cylindrical seat disposed around the magnetic hollow cylinder, an exciting coil disposed on the hollow cylindrical seat, a magnetic first member secured to a first magnet, a first portion of the hollow cylindrical seat, and a first portion of the exciting coil, and a magnetic second member secured to a second magnet, a second portion of the hollow cylindrical seat, and a second portion of the exciting coil; and
an energy supplying device disposed on an outer surface of the housing and including an inner winding disposed on the outer surface of the housing and electrically connected to the exciting coil, and an outer winding spaced from the inner winding.

2. The hammer drill of claim 1, wherein the ultrasonic vibration device further comprises the first and second magnets of bias magnetic field at two ends of the magnetic hollow cylinder respectively.

3. The hammer drill of claim 1, wherein the outer winding has a shape of one quarter arc.

4. The hammer drill of claim 1, wherein the anchor member is secured to a head of the axial fastener opposing the chuck.

5. The hammer drill of claim 1, wherein the axial fastener is hollow.

6. The hammer drill of claim 1, wherein the outer winding is electrically connected to a controller.

7. The hammer drill of claim 1, wherein the first and second magnets of bias magnetic field are neodymium magnets.

8. The hammer drill of claim 2, wherein the first and second magnets of bias magnetic field are neodymium magnets.
